(19) United States
(12) Patent Application Publication
(10) Pub. No.: US 2026/0263844 A1
(43) Pub. Date: Sep. 10, 2026

(54) Support for a Safety Line for a Fall Arrest System

(71) Applicant: MSA Europe GmbH, Rapperswill-Jona (CH)

(72) Inventors: Paul FISCHER, Berlin (DE); Eric HOLTKAMP, Berlin (DE); Wolfgang WEBER, Berlin (DE)

(21) Appl. No.: 19/164,318

(22) PCT Filed: Mar. 6, 2024
(86) PCT No.: PCT/EP2024/055859

§ 371 Date: Sep. 11, 2025

(30) Foreign Application Priority Data
Mar. 15, 2023 (DE) 10 2023 106 533.5

(51) Int. Cl. A62B 35/00

(52) U.S. Cl. CPC A62B 35/0068; A62B 35/0056; A62B 35/0087

(57) ABSTRACT

The claimed subject matter is directed to a support for a safety line for a fall arrest system comprising at least one supporting element having at least one a tubular element suitable for retaining a safety line and at least one attachment means to attach the support at least indirectly to at least one substructure, the supporting element and attachment means being connected by at least one connection element, wherein the supporting element allows an arc like guidance of the safety line, wherein further the tubular element is flexible and/or bendable and the attachment means comprises at least two base elements, wherein the base elements are movable with respect to each other and each base element is connected to a separate section of the supporting element and/or tubular element, and is directed to a fall arrest system comprising such a support.

The claimed subject matter is directed to a support for a safety line for a fall arrest system comprising at least one supporting element having at least one a tubular element suitable for retaining a safety line and at least one attachment means to attach the support to at least on substructure, the supporting element and attachment means being connected by at least one connection element.

In the prior art different fall arrest systems are known. These systems are used to secure a person working in high heights in case of a fall event. The person is wearing a personal protecting equipment (PPE), for example a harness, to which a lanyard is connectable, for example via a carabiner. The lanyard itself is connected to a transfastener and/or travelling device. Such a travelling device can be connected and disconnected from a rope or wire also called a life line and safety line, respectively. The travelling device can furthermore travel along the safety line to allow the person a freedom of movement.

In case of a fall the person thus stays connected to the safety line and the roof structure so that a fall can be intercepted. And in case of a fall event by respective energy absorbers, the fall of the person is dampened and the person is held by the horizontal safety line via a travelling device and/or a transfastener, the lanyard and the PPE.

In some examples the fall arrest system comprises a so called horizonal lifeline system. In such a horizontal lifeline system the safety line is connected to a horizonal structure like a roof or a rail system connected to the roof structure.

Beside the interception of a fall the horizontal lifeline system prevents the structure to which the system is connected, in particular the roof structure, in the moment of the user's fall from too high loads. To allow a movement of the user and a travel of the travelling device along the safety line, the safety line is held in a distance from the roof structure via posts, in particular constant force posts.

The safety line can be connected via supports in form of brackets to a substructure in form of these posts. To ensure a preload of the safety line the safety line is guided via the supports, like the brackets, along a predefined route. To allow a best possible adaptation of the horizontal lifeline to the roof structure, these supports have to be straight or shall form angles for different direction changes of the safety line along the substructure like the roof structure. Depending on the roof construction the angles changes can be horizontal or vertical, i.e. perpendicular to a normal vector of the substructure like the roof structure or can be inclined to the normal vector.

In known systems a plurality of different brackets have to be kept in stock and have to be carried with when installing the horizontal lifeline system to best adapt the horizontal lifeline system to the given roof structure. Alternatively a bending tool has to be used to adapt each of the brackets to the change in the respective angle of the roof. This leads however to a complicated installation procedure, in particular the installer has to have specific mechanical skills to adapt the respective bracket to the needs.

It is thus an object of the claimed subject matter to further develop known supports, in particular brackets, to overcome the disadvantages know in the prior art, in particular to provide a support that can be easily adapted to the needs for the specific roof structure, preferably allows a safe aligning to horizonal and/or vertical angle changes of a substructure.

This subject is achieved in that the supporting element allows an arc like guidance of the safety line, wherein the tubular element is at least partly flexible and/or bendable and the attachment means comprises at least two base elements, wherein the base elements are movable with respect to each other and each base element is connected to a separate section of the supporting element and/or tubular element.

For the support it is furthermore proposed that the supporting element comprises at least one, preferably rigid, sleeve, in particular connected to at least one end of the tubular element, optionally at least two sleeves, in particular connected to the ends of the tubular element.

For the before described embodiment it is preferred that the sleeve is at least partly comprised by and/or connected to the connection element.

It is also proposed that the tubular element is stretchable and/or compressible and/or the tubular element comprises at least one metal hose, at least one stripwound hose, at least one rubber hose, at least one rubber tube, at least one corrugated hose, at last one spring element, at least one coil spring element, at least one on block coiled wire, and/or a plurality, optionally at least two, at least three and/or at least four, rigid sections being movable and/or bendable with respect to each other, wherein preferably at least two sections, preferably all sections are supported by separate supporting elements, a plurality of sleeves.

A support can be furthermore characterized in that the safety line is insertable into and/or can extend through the supporting element, in particular the tubular element and/or the sleeve.

Furthermore it is preferred that a first base element is at least partly located and/or extends at least partly in a first plane and a second base element is at least partly located and/or extends at least partly in a second plane.

For the before described embodiment it is proposed that the first base element and the second base element are pivotable with respect to each other around at least one first axis being perpendicular to the first plane and/or the second plane and/or the first plane and the second plane are at least partly identical.

It is also alternatively or in combination to the before described embodiment proposed that the first base element and the second base element are pivotable with respect to each other around at least one second axis being parallel to the first plane, parallel to the second plane and/or perpendicular to the first axis, in particular the second axis lay in the first plane and/or the second plane and/or the second axis extends at perpendicular to at least a part of the safety line and/or at least a part of the tubular element.

A support can be furthermore characterized by at least one bearing element, wherein the base elements, in particular the first base element and the second base element, are movable, in particular pivotable, with respect to each other by the bearing element, wherein the bearing element preferably comprises at least one spacer, preferably located at least partly between the base elements, especially the first base element and the second base element.

Furthermore it proposed that the attachment means, the base element, the first base element and/or the second base element comprises at least one sheet metal, preferably at least two, more preferably a plurality of sheet metals, a cast iron material, at least one plastic material, at least one carbon material, at least one fiber composite material, at least one polymer material, at least one leaf spring, at least one at least partly bendable material, at least one at least partly permanently deformable material and/or at least one at least partly flexible material.

Also it is preferred that the attachment means, the base element, the first base element, and/or the second base element comprises at least one marking element, preferably comprising at least one cut-out, at least one material weakening, at least one visible marking and/or at least one hinge, optionally for bending, twisting and/or torsion of the attachment means, the base element, the first base element and/or the second base element.

A support can be characterized in that the connection element is, preferably around at least one third axis, pivotably connected to the attachment means, the base element, the first base element and/or the second base element, wherein the third axis is preferably parallel to the first axis or the second axis.

Advantageous embodiments of the support can be characterized in that at least one stop element to limit a relative movement of at least one of the base elements and/or at least one of the connection elements, in particular at least one first stop element to limit a movement around the first axis, at least one second stop element to limit a movement around the second axis and/or at least one stop element to limit a movement of the connection element relative to the attachment means, the base element, the first base element und/or the second base element, in particular around the third axis, wherein preferably the stop element, the first stop element and/or the second stop element comprises at least one recess, at least one elevation, at least one pin at least one indentation, and/or at least one depression, especially at least partly comprised by the attachment means, by the base element, by the first base element, by the second base element, and/or by the connection element.

Furthermore it is proposed that the base element, the first base element, the second base element, the attachment means and/or the connection element comprises a pair of stop elements, in particular a pair of complementary stop elements.

Finally it is proposed that the substructure comprises at least partly and/or is formed by at least one support structure, at least one roof structure, at least one rail system, preferably at least partly comprised by and/or connected to the support structure, at least one post, at least one constant force post, at least one anchor assembly, at least one horizontal life line system, at least one vertical life line system. at least one wall structure, at least one high storage, and/or at least one element of a an exterior and/or interior industrial application.

It is furthermore proposed that at least one base element is attachable to the substructure via at least one first attachment element.

The support can also be characterized in that the attachment means, in particular the bearing element, is attachable to the substructure via at least one second attachment element, wherein optionally the second attachment element is attached to and/or comprised by the bearing element.

For the before described embodiments it is proposed that the first attachment element and/or the second attachment element comprises at least one bolt, at least one screw and/or at least one threaded rod.

Optionally the bearing element comprises at last one ball joint and/or the bearing element allows a movement of the attachment means, in particular relative to the substructure and/or the second attachment element around at least one first bearing axis, at least one second bearing axis, optionally running perpendicular to the first bearing axis, and/or at least one third bearing axis, optionally running perpendicular to the first bearing axis and/or the second bearing axis.

Finally it is proposed for the support that the first base element and/or the second element at least partly enclose and/or surrounds the bearing element, in particular the ball joint, and/or the bearing element, in particular the ball joint, is at least partly located within at least one eyelet of the first base element and/or of the second base element.

The claimed subject matter furthermore provides a fall arrest system comprising at least one life line, in particular horizontal life line, and at least one support according to one of the preceding claims.

For the fall arrest system it is proposed that the fall arrest system further comprises at least one harness, in particular wearable by a user, at least one lanyard, optionally connectable to the harness, at least one safety line, optionally connectable to the lanyard and/or the harness, and/or at least one transfastener and/or travelling device, optionally connectable to the safety line, the harness and/or the lanyard.

The claimed subject matter is thus based on the astonishing perception that a support, in particular a bracket, can be realized such that during an installation process of a lifeline system the support can be adapted to the installation environment without the need to hold a plurality of different supports in stock and without the need to mechanically adapt the support to the specific installation situation. In particular the use of a bearing element comprising a ball joint allows a best possible adaptation to the environment.

By providing an attachment means that comprises at least two base elements that can be moved relative to each other and can be fixed in different positions relative to each other, it becomes possible to adapt the support to the specific needs in the specific installation environment.

In particular, in case the safety line has to be guided under a specific angle in a horizontal plane or in case the safety line has to be guided under different angles in a vertical plane, the movement of the base elements relative to each other allows a best possible adaptation.

To guide the safety line the support comprises supporting elements through which the safety line is guided and/or into which the lifeline is inserted. The supporting element is at least partly flexible and/or bendable to allow to follow the relative movement of the base elements. To adapt different distances between the connection elements and/or the sleeves due to the movement of the base elements the tubular element is preferably also stretchable and/or compressible.

To allow a smooth travel of the travelling device along the safety line the supporting element is connected to the attachment means via connection elements having a geometry being compatible with the travelling device. Further, the connection elements define a distance between the substructure, in particular the post and/or the roof structure, to which the attachment mean is connected at least indirectly on the one hand, and the safety line on the other hand.

It is preferred that the base elements are connected via a bearing element to each other. The bearing element might for example comprise at least spacer and at least one screw that extends through the spacer and respective connection holes in a base elements. This simultaneously allows to connect the base elements directly to the substructure, in particular to a constant force post, a rail system and/or a roof structure.

During the connection process of the support to the substructure the base elements can be positioned or aligned with respect to each other such that the safety line follows a wanted curve or path.

In particular the bearing element can allow a movement of the base elements in the horizontal plane but also in a vertical plane to allow a maximum flexibility. In addition the base elements can comprise at last one marking element. These marking elements can in particular comprise cut-outs in a flat profile to mark an area where a vertical angle change of the base element can be realized, for example via an additional tool in a manual fashion.

Furthermore a stop element for angle limitation can be integrated into the support, in particular base elements and/or connection elements. These stop elements can limit the relative movement of the base elements with regard to each other and/or can be used to limit a relative movement of connection elements with regard to the base elements.

The connection elements in particular comprise a rigid sleeve through which the safety line can be guided. The connection elements are connected to the attachment means, in particular the base elements, preferably in such a way that they can pivot around a connection point and/or around a third axis to the attachment means.

This ensures that a kinking of the safety line when entering the supporting element is avoided that might lead to a overstress for the safety line and might hinder a free movement of the travelling device along the safety line and the supporting element.

Between the sleeves and the connecting elements preferably a flexible and/or bendable tubular element is located. This tubular element can be formed as a spring through which the safety line is running. A spring element has the advantage that it is also stretchable and/or compressible to compensate length changes due to the movement of the base elements.

The tubular elements, in particular the spring, is a variable distance holder between the sleeves under safety line tension.

The tubular element allows a flexible angle change in all directions and simultaneously prevents the cable from kinking and allows a smooth travel of the travelling device along the safety line and the support.

By the before described construction the support adapts automatically to all necessary horizontal and vertical angles. In particular with only one rotational point, in particular in form of the bearing element, between the base elements this goal can be achieved. with one length of the supporting element, in particular the tubular element, different angles between the incoming safety line and the outgoing safety line can be realized. By at least one further rotational point, preferably two additional rotational points, at which the connection element(s) is/are pivotally connected to the base element(s) furthermore overstresses of the safety line at the entry point into the supporting element can be avoided, at least reduced.

Further advantages and features of the clamed subject-matter are explained with the help of different embodiments shown in the following figures in which

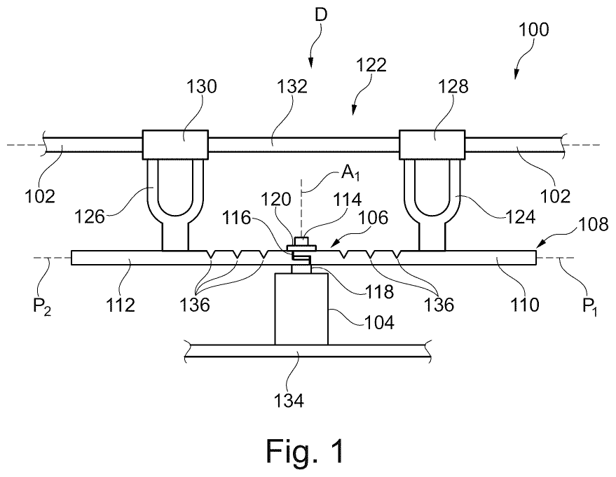

FIG. 1 shows a sideview of a first embodiment of a support;

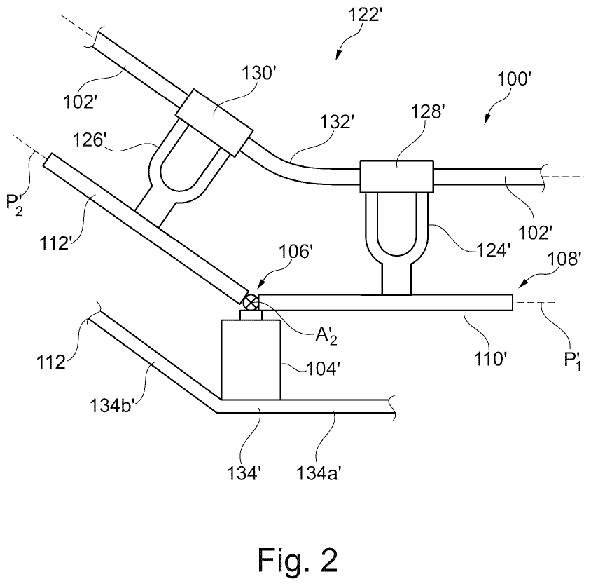

FIG. 2 shows a schematic sideview of a support according to a second embodiment;

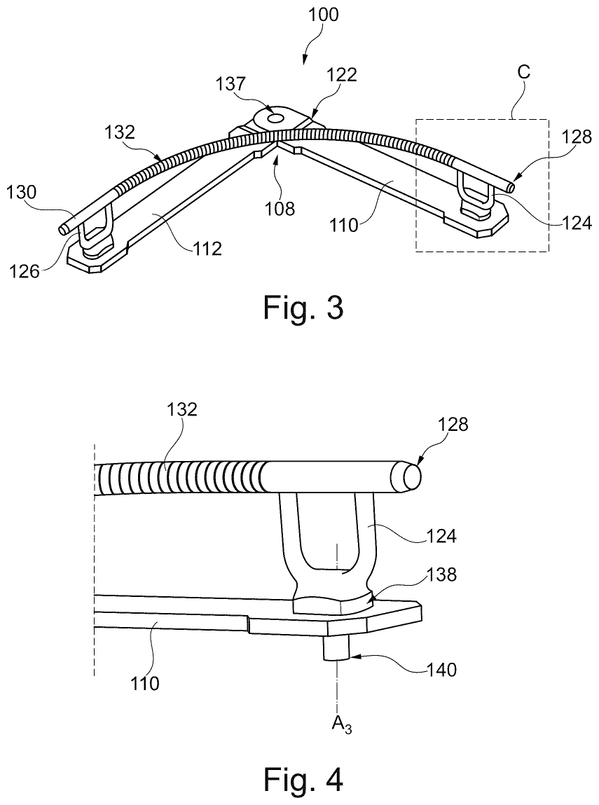

FIG. 3 shows a perspective view of a support according to the first embodiment;

FIG. 4 shows a perspective view of a detail of the support according to the first embodiment;

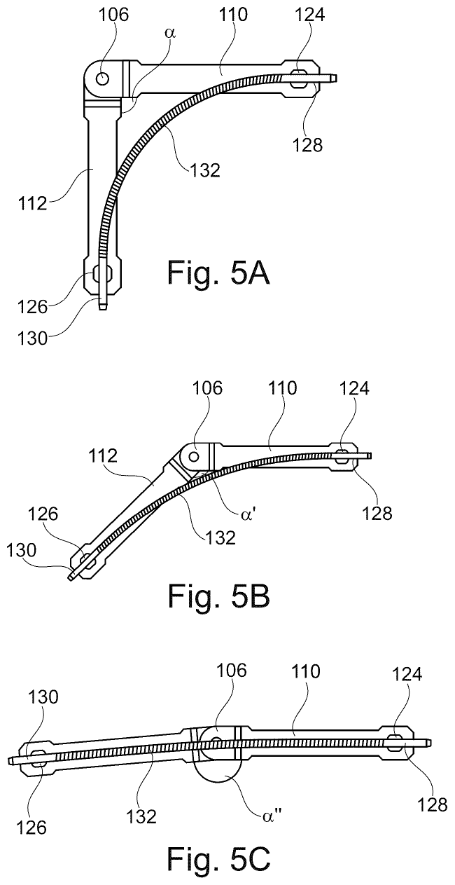

FIGS. 5a to 5c show views of the first embodiment of the support providing different angles for the safety line;

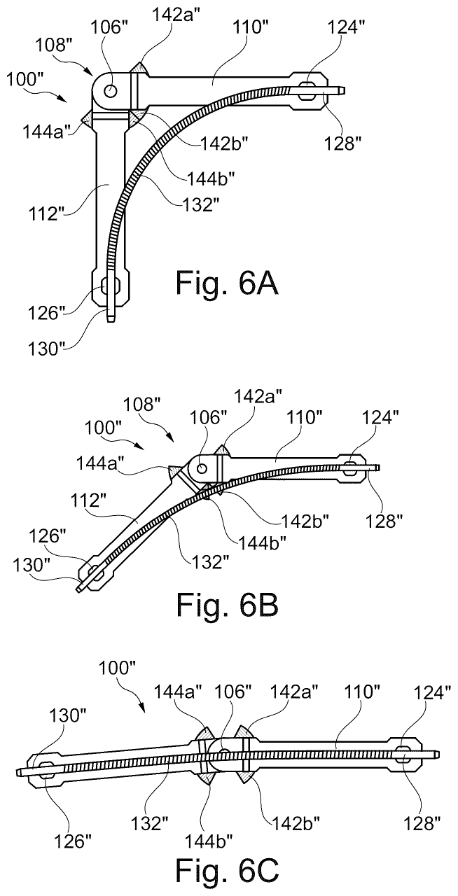

FIGS. 6a to 6c show views of a third embodiment of the support including stop elements;

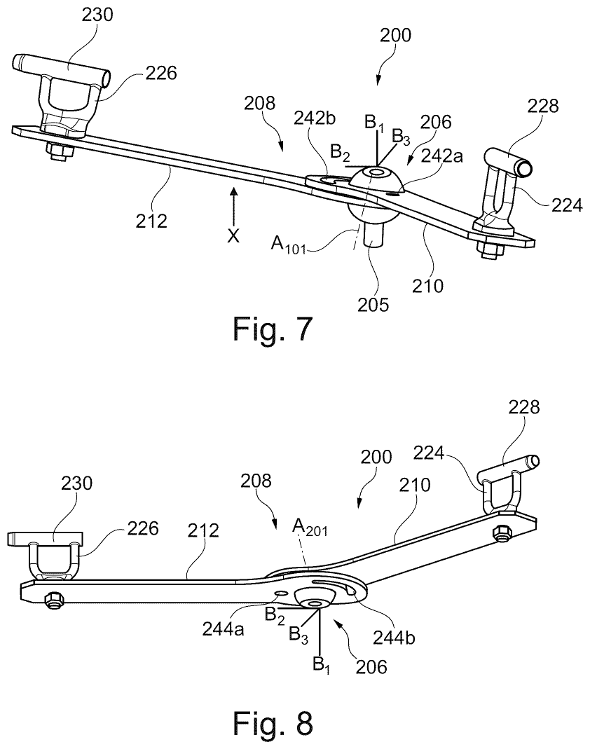

FIG. 7 shows a perspective view of a fourth embodiment of a support;

FIG. 8 shows a different perspective view of the support of FIG. 7; and

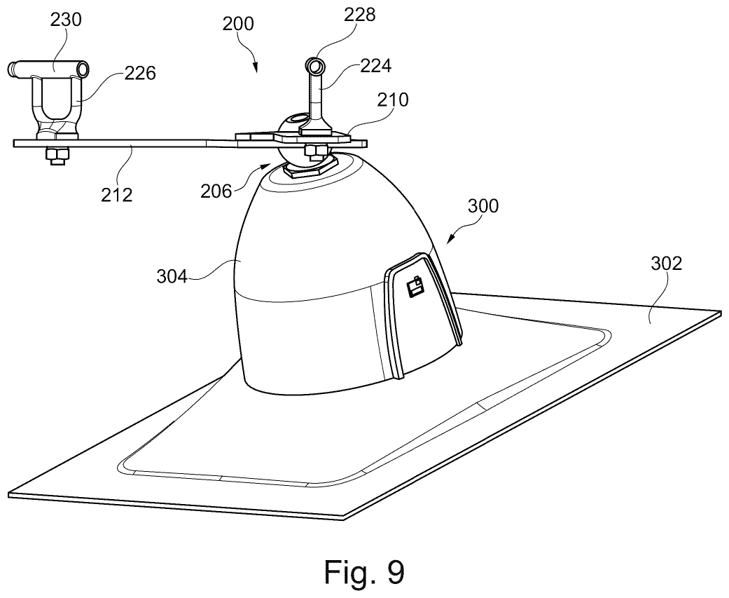

FIG. 9 shows a perspective view of the support of FIGS. 7 and 8 attached to a substructure in form of an anchor assembly including an energy absorber.

FIG. 1 shows a schematic sideview of a support according to the claimed subject-matter in form of a bracket 100. By the bracket 100 a safety line 102 of a fall arrest system in form of a horizontal lifeline system is guided.

The bracket 100 is connected to a substructure in form of a constant force post 104. The bracket 100 is connected to the post 104 via a bearing element 106. To the bearing element 106 an attachment means 108 of the bracket 100 is connected.

The attachment means 108 comprises a first base element 110 and a second base element 112. The bearing element 106 comprises a screw 114 extending through the first base element 110, a spacer 116 located between the first base element 110 and the second base element 112, through the second base element 112 and a further spacer 118 into a threaded hole in the post 104. Additionally a further spacer 120 maybe located above the first base element 110. Alternatively the bracket 100, in particular by at least one first attachment element the first base element 110 and/or the second base element 112 and/or by at least one second attachment element the bearing element 106, may be connected directly to a roof structure 134 and/or to a rail system that in turn is connected to the roof structure 134.

The bearing element 106 acts as a hinge that allows a relative movement of the first base element 110 relative to the second base element 112. In particular it allows a pivoting of the base elements 110, 112 relative to each other round a first axis A₁.

In other words the first base element 110 extends in a first plane P₁ and the second base element 112 extends in a second plane P₂. In FIG. 1 for the bracket 100 the first plane P₁ and the second plane P₂ are identical, at least parallel to each other.

A supporting element 122 of the bracket 100 is connected via a first connection element 124 and a second connection element 126 to the attachment means 108. In particular a first sleeve 128 of the supporting element 122 is connected via the connection element 124 to the first base element 110 whereas a second sleeve 130 of the supporting element 122 is connected to the second base element 112 via a connection element 126.

Between the sleeves 128, 130 a tubular element in form of a spring 132 is located. The tubular element 132 can be connected to the sleeves 128, 130 but might also be in lose work connection with the sleeves 128, 130.

The safety line 102 runs through the sleeve 128, the tubular element 132 and the sleeve 130. As the tubular element 132 is flexible and bendable it can follow a relative movement of the first base element 110 and the second base element 112 relative to each other. In this way the safety line 102 can be forced to follow an ark such that the safety line 102 entering the sleeve 128 enclose an angle to the safety line 102 when exiting the sleeve 130.

Thus the bracket 100 represents a variable bracket that can self-align to horizontal angle changes of the safety line 102. To allow a relative movement of the sleeves 128, 130 relative to the base elements 110, 112 the connection elements 124, 126 are pivotably connected to the base elements 110, 112, respectively. In this way the sleeves 128, 130 can align themself relative to the base elements 110 and 112 such that an additional stress or kinking of the safety line 102 can be avoided. In particular the sleeve 128 and the connection element 124 or the sleeve 130 and the connection element 126 form short straight brackets allowing smooth travel of the travelling device through the bracket 100 along the sleeves 128, the tubular element 132 and the sleeve 130.

To allow an adaptation in a vertical plane relative to a substructure, in particular the roof structure 134, it is also possible that the first base element 110 and/or the second base element 112 comprise marking elements, for example in form of cut-outs 136. These cut-outs 136 represent hinges at which the first base element 110 or the second base element 112 can be deformed to allow an additional alignment to vertical angle changes. In particular the first base element 110 and the second base element 112 can be deformed by a not shown tool.

FIG. 2 shows a schematic sideview of a second embodiment of a bracket 100′ that allows a self-alignment in the vertical plane. The elements of the bracket 100′ corresponding to the elements of the bracket 100 have the same reference number however with one apostrophe. The bracket 100 allows a safe alinement of the bracket 100 around the axis A₁. In other words its allows to self-align a horizontal angle changes of the safety line 102 wherein the horizontal plane is parallel to a roof structure 134 to which the post 104 is connected.

As mentioned before, there are, however, also situations in which the roof structure 134′ is extending in different planes. The bracket 100′ allows a self-alinement also with regard to such angle changes in a vertical direction. As shown in FIG. 2 the first base element 110′ extends in the first plane P₁′ whereas the second base element 112′ extends in a second plane P₂′ being inclined with regard to the first plane Pi'.

Both planes P₁′ and P₂′ run parallel to respective sections 134a′ and 134b′ of the roof structure 134′. To allow this form of the bracket 100′, and such as self-alignment function the bearing element 106′ is different from the bearing element 106 of the bracket 100. The bearing element 106′ allows a movement of the base element 110′ relative to the base element 112′ around an axis A₂′ that runs parallel to the roof structure 134′ compared to the perpendicular direction of the axis A₁ relative to roof structure 134 for the bracket 100.

Although shown separately from the horizontal self-alignment explained for bracket 100, the vertical self-alignment as explained for bracket 100′ can be realized in combination with the horizontal self-alignment as explained for bracket 100′. In particular by adapting the bearing element 106 and/or 106′, respectively, to allow both a relative movement around the first axis A₁ and the second axis A₂′, wherein the first axis A₁ and the second axis A₂′ are in particular perpendicular to each other (e.g., second axis A2′ runs perpendicular to at least a part of the safety line (120′) and/or at least a part of the tubular element (132′)), the necessary freedom of movement of the first and second base elements 110, 110,′, 112, 112′ can be provided.

FIG. 3 shows a perspective view onto the bracket 100. In the FIG. 3 the screw forming the hinge 106 is removed so that an opening 137 in the first base element 110 through which the screw 114 can be inserted is shown. In FIG. 3 the bracket 100 is shown in a configuration in which the first base element 110 is rotated round the axis A₁ relative to the second base element 112, so that the base elements 110, 112 enclose an angle of 90°.

FIG. 4 is a detailed view of the extract detail C of FIG. 3. As shown in FIG. 4 the first connection element 124 is connected to the first base element 110 at point 138. The connection is provided by a screw 140 reaching through the first base element 110 into the first connection element 124. This allows a relative movement of the connection element 124 relative to the base element 110 around the third axis A₃. In alternative embodiments the connection can be provided by a threaded rod connected to and/or comprised by the first connection element reaching through the first base element 110 and being secured by a nut element at least partly threaded onto the threaded rod.

For the bracket 100 the third axis A₃ is parallel to the first axis A₁. In not shown embodiments, in particular the bracket 100′, the third axis A₃ might run parallel to the second axis A₂′ to reach a vertical self-alignment also for the connection elements. Also two third axis might be provided to allow a combined vertical and horizontal self-alignment, wherein in particular a first third axis is running parallel to the first axis Ai and a second third axis is running parallel to the second axis A₂.

In FIGS. 5a to 5c respective top views onto the bracket 100 in the direction D of FIG. 1 are shown. In FIG. 5a the bracket 100 is shown in a 90° corner configuration. This means that the first base element 110 and the second base element 112 enclose an angle α of 90°.

In FIG. 5b the first base element 110 and the second base element enclose an angle a′ of 135°. Thus the bracket 100 is shown in a 135° configuration.

In FIG. 5c the bracket 100 is shown in a 175° corner configuration. This means that the first and the second base elements 110, 112 enclose an angle α″ of 175°.

From the FIGS. 5a to 5c it is apparent that the bracket 100 adapts automatically to all necessary horizontal angles. By the provision of the connection point provided by the bearing element 106 any wanted angle between the first base element 110 and the second base element 112 can be provided. Furthermore due to the pivotable connection of the connection elements 124, 126 with the base elements 110, 112 an overstress of the safety line 102 running through the bracket 100 can be reduced. Furthermore it is possible to realize the respective configurations with one and the same tubular element 132 having a constant length, this is in particular accomplished by realizing the tubular element 132 as a spring element allowing both a compression and stretching.

In FIGS. 6a to 6c a further embodiment of a bracket 100″ is shown. Elements of the bracket 100″ that correspond to the elements of bracket 100 have the same reference number, however with two apostrophes.

Compared to the bracket 100 the bracket 100″ comprises a pair of stop elements 142a″, 142b″ and a pair of stop elements and 144a″ and 144b″. A first pair of stop elements 142a″ and 142b″ is comprised by the first base element 110″ whereas a pair of second stop elements 144a″ and 144b″ is comprised by the second base element 112″.

As can be taken from FIG. 6a one of the stop elements 142a″, 142b″ of the first base element 110″ get in contact with on of the stop elements 144a″, 144b″ when the first base element 110″ and the second base element 112″ enclose an angle of 90° and 270°, respectively.

The stop elements 142a″, 142b″, 144a″, 144b″ restrict the movement of the base elements 110″, 112″′ to angles being equal or greater than 90° and smaller or equal to 270° but prohibit smaller angles than 90° and greater angels than 270°.

In FIGS. 6b and 6c the first base element 110″ and the second base element 112″ enclose an angle of 135°/225° (FIGS. 6b) and 175°/185° (FIG. 6c), respectively. In these configurations the stop elements 142a″, 142b″ on the one hand and 144a″ and 144b″ on the other hand are spaced apart from each other.

Although for the bracket 100″ a pair of stop elements being located on or comprised by the first base element 110″ and the second base element 112″, respectively has been described the skilled person understands that only a single stop element could be provided on the first base element or the second base element or that a first stop element of a pair of stop elements is located on the first base element whereas a second stop element of the pair of stop elements is located on the second base element.

In FIG. 7 a further embodiment of a bracket 200 is shown. The elements of bracket 200 that correspond to the elements of the bracket 100 have the same reference numbers increased by 100. For the ease of the representation the supporting element has been omitted in the FIG. 7 as well as in the FIGS. 8 and 9 showing the bracket 200 from different directions.

The bracket 200 is attachable to a substructure by a second attachment element in form of a threaded rod 205 connected to and/or comprised by the bearing element 206. The bearing element 206 comprises a ball joint such that the attachment means 208 is pivotable relative to the substructure around a first bearing axis B₁, a second bearing axis B₂ running perpendicular to the first bearing axis Bi and a third bearing axis B₃ running perpendicular to the first bearing axis Bi and the second bearing axis B₂. The all joint 206 is received within respective eyelets formed in the first base element (210) and the second base element (212), respectively.

Furthermore the first base element 210 is pivotable relative to the second base element 212 around a first axis A101 being pivotable around the first, second and third bearing axis B₁, B₂, B₃.

The bracket 200 furthermore comprises a stop elements. Each of the first base element 210 and the second base element 212 comprises a pair of stop elements. The stop elements of the respective pair are however of different type. The pair of stop elements comprised by the first base element 210 comprises a first stop element in form of a pin 242a and a second stop element in form of a recess 242b. The pair of stop elements comprised by the second base element 212 comprises a first stop element in form of a pin 244a and a second stop element in form of a recess 244b as shown in FIG. 8.

The pin 242a, i.e. the first stop element of the first base element 210, is at least partly received in the recess 244b, i.e. the second stop element of the second base element 212.

Furthermore the pin 244a, i.e. the first stop element of the second base element 212, is at least partly received in the recess 242b, i.e. the second stop element of the first base element 210.

The recesses 242b, restricts the movement of the pin 244a and thus the movement of the first base element 210 relative to the second base element 212 whereas the recess 244b restricts the movement of the pin 242a and thus the movement of the second base element 212 relative to the first base element 210. By choosing the length of the recesses 242b, 244b the extend of relative movement of the first base element 210 relative to the second base element 212 can be adapted

FIG. 8 shows a perspective view onto the bracket 200 in the direction X in FIG. 7. For the ease of representation the second attachment element 205 is omitted in the FIG. 8.

FIG. 9 shows the bracket 200 being attached via the second attachment element to an anchor assembly 300. The anchor assembly 300 comprises a base plate 302 that can be connected to a substructure, like a roof structure. The anchor assembly 300 furthermore comprises a housing 304 in which an energy absorber connecting the bracket 200 with the base plate 302 is located.

In particular the ball joint comprised by the bearing element 206 allows to align the bracket 200, in particular its attachment means 208, the first base element 210, the second base element 212, the first connection element 224, the second connection element 226 and/or the supporting element in any desired orientation with respect to the substructure, in particular the base plate 302, the housing 304 and/or the anchor assembly 300.

The features disclosed in the claims, the specification and the drawings may be essential for the different embodiments of the claimed subject-matter, eighter separately or in any combination with each other.

### REFERENCE SIGN LIST

100, 100′, 100″, 200 bracket
102, 102 safety line
104, 104′ constant force post
106, 106′, 106″, 206 bearing element
108, 108′, 108″, 208 attachment means
110, 110′, 110″, 210 1st base element
112, 112′, 112″, 212 2nd base element
114 screw
116 spacer
118 spacer
120 spacer
122, 122′ supporting element
124, 124′, 124″, 224 connection element
126, 126′, 126″, 226 connection element
128, 128′, 128″, 228 sleeve
130, 130′, 130″, 230 sleeve
132, 132′. 132″ spring
134, 134°roof structure
134a′, 134b′ section
136 cut-out
137 opening
138 point
140 screw
142a″, 142b″ stop element
144a″, 144b″ stop element
242a, 244a pin
242b, 244b recess
205 threaded rod
300 anchor assembly
302 base plate
304 housing
A₁, A₂′, A₃ axis
B₁, B₂, B₃ bearing axis
C extract
D direction
X direction
P₁, P₁′ plane
P₂, P₂′ plane
a, a′, a″ angle

1. A support for a safety line for a fall arrest system comprising at least one supporting element having at least one a tubular element suitable for retaining a safety line and at least one attachment means to attach the support at least indirectly to at least one substructure the supporting element and attachment means being connected by at least one connection element wherein the supporting element allows an arc like guidance of the safety line characterized in that the tubular element is at least partly flexible and/or bendable and the attachment means comprises at least two base elements, wherein the base elements are movable with respect to each other and each base element is connected to a separate section of the supporting element and/or tubular element

2. The support according to claim 1, characterized in that the supporting element comprises at least one, preferably rigid, sleeve in particular connected to at least one end of the tubular element optionally at least two sleeves in particular connected to the ends of the tubular element

3. The support according to claim 2, characterized in that the sleeve is at least partly comprised by and/or connected to the connection element

4. The support according to claim 1, characterized in that the tubular element is stretchable and/or compressible and/or the tubular element comprises at least one metal hose, at least one stripwound hose, at least one rubber hose, at least one rubber tube, at least one corrugated hose, at last one spring element at least one coil spring element, at least one on block coiled wire, and/or a plurality, optionally at least two, at least three and/or at least four, rigid sections being movable and/or bendable with respect to each other, wherein preferably at least two sections, preferably all sections are supported by separate supporting elements, a plurality of sleeves.

5. The support according to claim 1, characterized in that the safety line is insertable into and/or can extend through the supporting element in particular the tubular element and/or the sleeve

6. The support according to claim 1, characterized in that a first base element is at least partly located and/or extends at least partly in a first plane (P1, P1′) and a second base element is at least partly located and/or extends at least partly in a second plane (P2, P2′).

7. The support according to claim 6, characterized in that the first base element and the second base element are pivotable with respect to each other around at least one first axis (A1) being perpendicular to the first plane and/or the second plane and/or the first plane and the second plane are at least partly identical.

8. The support according to claim 6, characterized in that the first base element and the second base element are pivotable with respect to each other around at least one second axis (A2′) being parallel to the first plane (P1′), parallel to the second plane (P2′) and/or perpendicular to the first axis (A1), in particular the second axis (A2′) lays in the first plane and/or the second plane and/or runs perpendicular to at least a part of the safety line and/or at least a part of the tubular element

9. The support according to claim 1, characterized by at least one bearing element wherein the base elements in particular the first base element and the second base element are movable, in particular pivotable, with respect to each other by the bearing element wherein the bearing element preferably comprises at least one spacer preferably located at least partly between the base elements especially the first base element and the second base element.

10. The support according to one claim 1, characterized in that the attachment means the base element the first base element and/or the second base element comprises at least one sheet metal, preferably at least two, more preferably a plurality of sheet metals, a cast iron material, at least one plastic material, at least one carbon material, at least one fiber composite material, at least one polymer material, at least one leaf spring, at least one at least partly bendable material, at least one at least partly permanently deformable material and/or at least one at least partly flexible material.

11. The support according to one claim 1, characterized in that the attachment means the base element the first base element and/or the second base element comprises at least one marking element preferably comprising at least one cut-out at least one material weakening, at least one visible marking and/or at least one hinge, optionally for bending, twisting and/or torsion of the attachment means the base element, the first base element and/or the second base element

12. The support according to one claim 1, characterized in that the connection element is, preferably around at least one third axis (A3), pivotably connected to the attachment means the base element the first base element and/or the second base element wherein the third axis (A3) is preferably parallel to the first axis (A1) or the second axis (A2′).

13. The support according to claim 1, characterized by at least one stop element to limit a relative movement of at least one of the base elements and/or at least one of the connection elements, in particular at least one first stop element to limit a movement around the first axis (A1), at least one second stop element to limit a movement around the second axis (A2) and/or at least one stop element to limit a movement of the connection element relative to the attachment means the base element the first base element and/or the second base element in particular around the third axis (A3), wherein preferably the stop element, the first stop element and/or the second stop element comprises at least one recess at least one elevation, at least one pin at least one indentation and/or at least one depression, especially at least partly comprised by the attachment means, by the first base element, by the second base element and/or by the connection element.

14. The support according to claim 13, characterized in that the base element, the first base element, the second base element, the attachment means and/or the connection element comprises a pair of stop elements, in particular a pair of complementary stop elements.

15. The support according to claim 1, characterized in that the substructure comprises at least partly and/or is formed by at least one support structure, at least one roof structure at least one rail system, preferably at least partly comprised by and/or connected to the support structure, at least one post, at least one constant force post at least one anchor assembly at least one horizontal life line system, at least one vertical life line system. At least one wall structure, at least one high storage, and/or at least one element of a an exterior and/or interior industrial application.

16. The support according to claim 1, characterized in that at least one base element is attachable to the substructure via at least one first attachment element.

17. The support according to claim 1, characterized in that the attachment means, in particular the bearing element, is attachable to the substructure via at least one second attachment element wherein optionally the second attachment element is attached to and/or comprised by the bearing element.

18. The support according to claim 16, characterized in that the first attachment element and/or the second attachment element comprises at least one bolt, at least one screw and/or at least one threaded rod.

19. The support according to claim 16, characterized in that the bearing element comprises at last one ball joint and/or the bearing element allows a movement of the attachment means, in particular relative to the substructure and/or the second attachment element around at least one first bearing axis (B1), at least one second bearing axis (B2), optionally running perpendicular to the first bearing axis (B1), and/or at least one third bearing axis (B3), optionally running perpendicular to the first bearing axis (B1) and/or the second bearing axis (B2).

20. The support according to claim 9, characterized in that the first base element and/or the second element at least partly enclose and/or surrounds the bearing element in particular the ball joint and/or the bearing element in particular the ball joint is at least partly located within at least one eyelet of the first base element and/or of the second base element.

21. Fall arrest system comprising at least one safety line in particular horizontal life line, and at least one support according to one of the preceding claims.

22. Fall arrest system according to claim 21, further comprising at least one harness, in particular wearable by a user, at least one lanyard, optionally connectable to the harness, at least one safety line, optionally connectable to the lanyard and/or the harness, and/or at least one transfastener and/or traveling device, optionally connectable to the safety line, the harness and/or the lanyard.
